(19) United States
(12) Patent Application Publication
(10) Pub. No.: US 2016/0091415 A1
(43) Pub. Date: Mar. 31, 2016

(54) OBJECT INFORMATION ACQUIRING APPARATUS

(71) Applicant: CANON KABUSHIKI KAISHA, Tokyo (JP)

(72) Inventors: Yukio Furukawa, Kyoto-shi (JP); Yasufumi Asao, Kyoto-shi (JP)

(21) Appl. No.: 14/851,024

(22) Filed: Sep. 11, 2015

(30) Foreign Application Priority Data
Sep. 30, 2014 (JP) 2014-201034

(51) Int. Cl. G01N 21/17

(52) U.S. Cl. CPC G01N 21/1702; G01N 2021/1708; G01N 2201/106; G01N 2201/0826; G01N 2201/067

(57) ABSTRACT

An apparatus includes a light source that generates light; a light irradiation unit that causes an acoustic wave to be generated from an object by irradiating a light irradiation region on a surface of the object with the light; a reception unit that receives the acoustic wave; an acoustic lens that is disposed such that the reception unit can selectively receive the acoustic wave from a predetermined direction; a moving unit that moves a focal point of the acoustic lens inside the object in an in-plane direction of the light irradiation region; and an acquisition unit that acquires information on a characteristic of the object based on the reception result of the reception unit, wherein the size of the focal point formed by the acoustic lens is smaller than the light irradiation region.

### BACKGROUND OF THE INVENTION

1. Field of the Invention

The present invention relates to an object information acquiring apparatus.

2. Description of the Related Art

Research on optical imaging apparatuses configured to irradiate an object with light from a light source (e.g. laser), and imaging the information on the inside of the object acquired based on the radiated light, is actively ongoing in medical fields. One example of an optical imaging technique is photoacoustic tomography (PAT). In PAT, an object is irradiated with pulsed light generated from a light source, and an acoustic wave generated from a tissue, which absorbed the energy of pulsed light propagated and diffused inside the object, is detected. This phenomenon generated by a photoacoustic wave is called a “photoacoustic effect”, and an acoustic wave generated by the photoacoustic effect is called a “photoacoustic wave”. A subject portion, such as a tumor and blood vessel, often has a higher light energy absorption rate than peripheral tissue thereof, and momentarily expands by absorbing more light than the peripheral tissue. The photoacoustic wave generated by this expansion is detected by an acoustic wave detection element (probe), and a reception signal, which is the detection result, is acquired. By mathematically analyzing this reception signal, the sound pressure distribution of the photoacoustic wave generated by the photoacoustic effect inside the object can be imaged. The image acquired by this imaging is called a “photoacoustic wave image”. Based on the photoacoustic wave image, the optical characteristic distribution (particularly light absorption coefficient distribution), which is characteristic information inside the object, can be acquired. The characteristic information can also be used for the quantitative measurement of a specific substance inside the object, such as glucose, hemoglobin included in blood.

On the other hand, improving the resolution of the apparatus in order to image more microscopic light absorbers using the photoacoustic effect is demanded. For this purpose, the development of photoacoustic microscopes that increase the resolution of photoacoustic imaging by focusing sound or converging pulsed light is progressing.

In Konstantin Maslov, Gheorghe Stoica, Lihong V. Wang, In vivo dark-field reflection-mode photoacoustic microscopy, Mar. 15, 2005, Vol. 30, No. 6, Optics Letters, an ultrasonic focus type photoacoustic microscope, that can image blood vessels existing near the skin at high resolution by using an acoustic lens, is presented.

### SUMMARY OF THE INVENTION

In the case of Konstantin Maslov, Gheorghe Stoica, Lihong V. Wang, In vivo dark-field reflection-mode photoacoustic microscopy, Mar. 15, 2005, Vol. 30, No. 6, Optics Letters, an optical irradiation system that irradiates an area in the vicinity of the focal point of the acoustic lens with pulsed light is provided. Therefore in order to acquire a two-dimensional tomographic image or three-dimensional image, the optical irradiation system and the ultrasonic detection element, which includes the acoustic lens, must be moved simultaneously for scanning, hence the size of the scanning system increases. In a case that an object is a human face or the like, using a large apparatus may raise safety issues and a burden imposed on the object.

With the foregoing in view, it is an object of the present invention to provide a downsizable object information acquiring apparatus (photoacoustic microscope).

To achieve the above object, the present invention adopts the following configuration. In other words, an aspect of the present invention is an object information acquiring apparatus including: a light source that generates light; a light irradiation unit that causes an acoustic wave to be generated from an object by irradiating a light irradiation region on a surface of the object with the light; a reception unit that receives the acoustic wave; an acoustic lens that is disposed such that the reception unit can selectively receive the acoustic wave from a predetermined direction; a moving unit that moves a focal point of the acoustic lens inside the object in an in-plane direction of the light irradiation region; and an acquisition unit that acquires information on a characteristic of the object based on the reception result of the reception unit, wherein the size of the focal point formed by the acoustic lens is smaller than the light irradiation region.

According to the present invention, a downsizable object information acquiring apparatus (photoacoustic microscope) can be provided.

Further features of the present invention will become apparent from the following description of exemplary embodiments with reference to the attached drawings.

### BRIEF DESCRIPTION OF THE DRAWINGS

FIG. 1 is a diagram depicting Example 1 of an object information acquiring apparatus according to an embodiment of the present invention;

FIG. 2A to FIG. 2C are diagrams depicting a structure of the light irradiation unit according to Example 1;

FIG. 3A to FIG. 3F are diagrams depicting light distribution in the light irradiation region according to Example 1;

FIG. 4 is a diagram depicting Example 2 of the object information acquiring apparatus according to an embodiment of the present invention; and

FIG. 5 is a diagram depicting Example 3 of the object information acquiring apparatus according to an embodiment of the present invention.

### DESCRIPTION OF THE EMBODIMENTS

The basic configuration and definitions of an object information acquiring apparatus according to an embodiment of the present invention will now be described.

(Pulsed Light Source)

If the object is a living body, a pulsed light source radiates light having a wavelength that is absorbed by specific components out of the components constituting the living body. To efficiently generate a photoacoustic wave, the pulse width is preferably several nsecs. to 100 nsecs. For the light source, a laser, a light emitting diode, a flash lamp or the like may be used. Various lasers can be used for the laser, such as a solid-state laser, a gas laser, a dye laser and a semiconductor laser. The wavelength of the light source used for this embodiment is preferably a wavelength by which light propagates into the object. In concrete terms, a wavelength of 500 nm or more and 1200 nm or less is preferable if the object is a living body.

(Light Transmission Unit)

A light transmission unit allows light emitted from the pulsed light source to reach the later mentioned light irradiation unit. The light transmission unit can be, for example, a type constituted by a plurality of optical fibers, and a type that propagates the light in a space using such optical elements as a mirror and a lens.

(Light Irradiation Unit)

The light irradiation unit irradiates an object such as a living body with light transmitted by the light transmission unit. It is preferable that the irradiation intensity and light distribution on the object are adjusted to be the optimum. If the light transmission unit is constituted by a plurality of optical fibers, it is preferable that the emission portions of the optical fibers and the centers of the light beams emitted from the respective optical fibers to the object are arranged concentrically. Then the difference of the light quantity between the center portion and peripheral portion of the later mentioned light irradiation region can be small, which improves the uniformity of the light quantity. In the photoacoustic microscope, in a case the light irradiation unit is used for scanning together with the acoustic wave detection element, the size of the driving mechanism of the apparatus tends to become large. Therefore the light irradiation unit, of which position is fixed, is advantageous in terms of downsizing the apparatus.

(Light Irradiation Region)

A light irradiation region is a region on the surface of the object, is a specific region irradiated with light from the light irradiation unit, and is a closed region being irradiated with light. The light irradiation region is a concept that is different from the light quantity distribution inside the object. The state of the object surface that is “irradiated” with the light is defined as the state when the intensity of the irradiation light on the surface of the object is a predetermined threshold or more. In this embodiment, the predetermined threshold is set to a value that can ensure the intensity of light by which the photoacoustic measurement is substantially possible.

(Acoustic Wave Detection Element)

An acoustic wave detection element is an element that receives a photoacoustic wave which is generated on the surface and inside the object by the radiated pulsed light, and converts the received photoacoustic wave into an electric signal (reception signal), which is an analog signal. Any acoustic wave detection element can be used here if the element can receive the acoustic wave signal, such as an element using the piezoelectric phenomenon, an element using the resonance of light, and an element using the change in electrostatic capacitance. Furthermore, a later mentioned acoustic lens is disposed so that an acoustic wave from a desired direction can be selectively received. The acoustic wave detection element and the acoustic lens correspond to the reception unit. The size of the focal point formed by the acoustic lens is typically determined from the frequency of the target acoustic wave, the opening of the acoustic wave detection element, and the focal length of the acoustic lens.

(Scanning Unit)

A scanning unit performs scanning with an acoustic wave detection element, and allows the focal position of the acoustic lens of the acoustic wave detection element to be scanned one-dimensionally or two-dimensionally along the object in the in-plane direction of the light irradiation region (in a direction roughly parallel with the light irradiation region).

(Scanning Range)

A scanning range is a range where the focal position of the acoustic wave detection element is scanned. By setting a range that is smaller than the light irradiation region as the desired scanning range, the photoacoustic wave from the object in the scanning range can be received without fail.

(Signal Acquiring Unit)

The signal acquiring unit acquires an electric signal acquired by the acoustic wave detection element. For efficient processing, it is desirable to include an A/D conversion unit, an amplifier or the like to convert an analog signal into a digital signal.

(Signal Processing Unit)

The signal processing unit generates a two-dimensional or three-dimensional photoacoustic image or optical characteristic distribution inside the object from the electric signals acquired by the signal acquiring unit. To generate the photoacoustic wave image, envelope detection is performed on the electric signals, and a signal value at each time is replaced with a signal value in the depth direction (Z axis direction) of the object. In other words, one-dimensional image information in a desired direction (Z axis direction) can be acquired in one measurement. By scanning the information one-dimensionally or two-dimensionally, a two-dimensional or three-dimensional photoacoustic image in the object is generated. The signal processing unit can be implemented by a circuit or computer that includes a CPU and is operated by a program.

(Display Unit)

A display unit is a display device or the like that displays an image generated by the signal processing unit. Various types of images are possible for the display image. For example, a tomographic image of an object in the horizontal plane directions (XY plane directions), and a tomographic image of the object in the vertical plane directions (XZ plane directions) are displayed. An XY plane maximum intensity projection (MIP) image where maximum intensity is projected in the Z direction, or a three-dimensional image in which the tomographic images in the XY plane are combined, may be displayed. Various display methods are also possible. For example, the above mentioned images may be displayed side by side, or may be displayed in a superposed state.

### Example 1

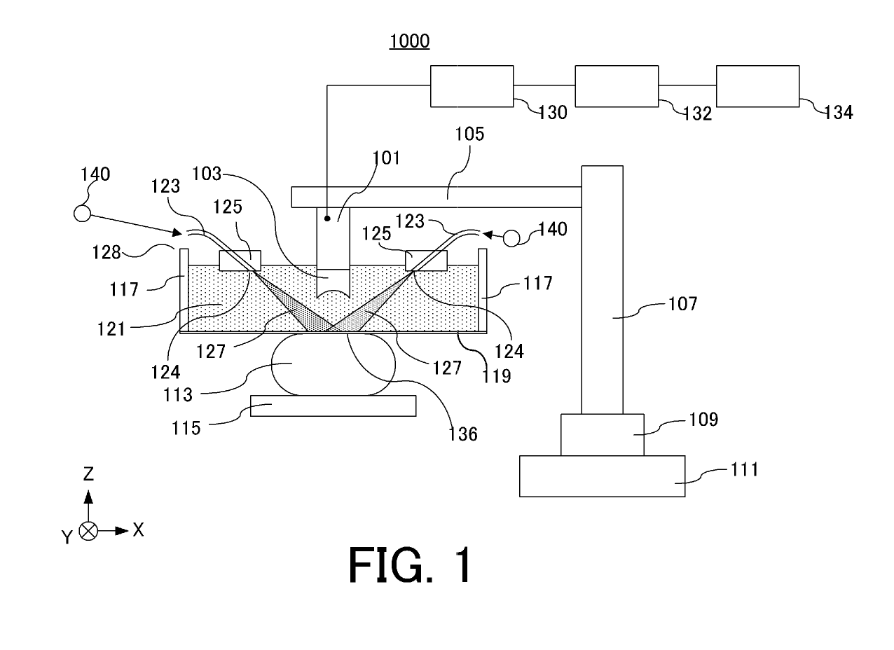

FIG. 1 is a diagram depicting Example 1 of the object information acquiring apparatus according to an embodiment of the present invention. The object information acquiring apparatus (e.g. photoacoustic microscope) 1000 (hereafter called “apparatus 1000”) of Example 1 has an acoustic wave detection element 101, which uses PZT as a piezoelectric material (hereafter called “element 101”), and an acoustic lens 103 disposed on the tip of the element 101. Further, the apparatus 1000 has a horizontal arm 105 to support the element 101, and a vertical arm 107 to support the horizontal arm 105. The vertical arm 107 is disposed on an X axis stage 111 and a Y axis stage 109. The vertical arm 107 can be moved in the X direction by driving the X axis stage 111, and can be moved in the Y direction by driving the Y axis stage 109. By moving the vertical arm 107 in the X direction and the Y direction, the element 101 can perform two-dimensional scanning in the XY directions. The X axis stage 111 and the Y axis stage 109 become larger as the total weight of each composing element connected thereto increases, since more driving power is demanded.

The object 113 is disposed on a support table 115. A moving mechanism (not illustrated) in the Z direction moves the object 113 and the support table 115 in the Z direction. The moving mechanism in the Z direction is manually operated so as to match the target observation portion of the object 113 and the focal position of the acoustic wave detection element 101. The accuracy of this alignment in the Z direction is not as strict as the XY directions, since imaging is possible if the portion is within a range of the depth of focus, hence the alignment in the Z direction may be performed manually. The moving mechanism in the Z direction, which does not use electric control, as in the case of the X axis stage 111 and the Y axis stage 109, does not contribute to increasing the size of the apparatus 1000. A water tank 128, which is a container, is constituted by a side wall (side portion) 117 and a thin film (bottom portion) 119 which receives liquid, and holds water (acoustic coupling agent) 121, which is a liquid that can propagate light and an ultrasonic wave therein. The thin film 119 is made from a material that transmits light and ultrasonic waves. The light irradiation unit that radiates light is constituted by an optical fiber 123 which functions as a unit that transmits light from the pulsed light source 140, and an optical fiber support unit 125 that supports the optical fiber 123. The light irradiation region 136 is formed by irradiating the object 113 with the light 127 emitted from the optical fiber 123. The optical fiber 123 is optically connected to a pulsed light source (not illustrated) constituted by a titanium sapphire laser which generates pulsed light of which wavelength is 800 nm, pulse width is 20 nsecs., and repeat frequency is 10 Hz. For the pulsed light source 140, a single light source may be guided using a plurality of optical fibers, or a plurality of light sources may be guided using a plurality of optical fibers.

The amount of water 121 is adjusted so that the end face 124 of the optical fiber 123 is positioned in the water 121, in other words, the optical fiber 123 contacts the water 121. This is to avoid the presence of an air layer between the optical fiber 123 and the water 121, since the light irradiation region or the irradiation pattern changes depending on the thickness of the air layer. The photoacoustic wave generated from the object 113 by the irradiation of the light 127 propagates through the thin film 119 and the water 121, and reaches the element 101 via the acoustic lens 103. The element 101 receives the reached photoacoustic wave and converts the photoacoustic wave into an analog electric signal. The element 101 can selectively receive a photoacoustic wave generated from a desired direction (Z direction) by the function of the acoustic lens 103. Imaging is possible if the object is within a range of the depth of focus. Therefore the position of the object 113 in the Z direction is adjusted so that the target observation portion of the object 113 is located near the focal point. The element 101 receives the photoacoustic wave via the acoustic lens 103, and outputs the electric signal, which is the reception result.

The signal acquiring unit 130 acquires an electric signal, outputted by the element 101, via an electric wire or the like. The signal acquiring unit 130 amplifies the acquired electric signal, performs A/D conversion, and sends the A/D-converted digital signal to the subsequent step. The signal processing unit 132 inputs the digital signal sent from the signal acquiring unit 130, and generates the characteristic information of the object near the focal position where the signal was acquired. This means that the characteristic information of the object is the imaged-characteristic information of the object near the focal position inside the object. In other words, “to scan one-dimensionally” in this example means to acquire a tomographic image on the XZ plane while moving the imageable line (of which center is a focal point in the Z direction) in the X direction. In the same manner, “to scan two-dimensionally” means to acquire a three-dimensional image while moving an imageable line (of which center is a focal point in the Z direction) in the X and Y directions.

The display unit 134 is a liquid crystal display or the like that displays an image generated by the signal processing unit 132.

During photoacoustic measurement, the light irradiation unit irradiates the surface of the object 113 with light in a predetermined light irradiation region, which does not change over time. The range of the predetermined light irradiation region is set to be larger than the two-dimensional scanning range of the element 101. Then the element 101 can two-dimensionally scan in the predetermined light irradiation region. In other words, it is unnecessary to move the position of the light irradiation unit in the two-dimensional scanning by the element 101, hence the light irradiation unit can be independent from the X axis stage 111 and the Y axis stage 109. Therefore the total weight of the composing members linked to the X axis stage 111 and the Y axis stage 109 becomes lighter since the light irradiation unit is not included, and the power required for driving becomes less accordingly. As a result, the sizes of the X axis stage 111 and the Y axis stage 109, and the power feeding mechanism or the like, to supply energy to the X axis stage 111 and the Y axis stage 109, can be reduced. Further, the shape of the apparatus 1000 can be compact. In other words, the apparatus 1000 can be downsized.

In the acoustic lens 103, the focal point thereof is aligned to a depth (a position in Z direction) to be imaged in the object 113 in the Z direction (approximately normal line direction of the light irradiation region). This alignment is performed by moving the support table 115 vertically in the Z direction. Thus the focal point of the acoustic lens 103 is aligned in the Z direction. Then the element 101 one-dimensionally scans (X direction) by the driving of the X axis stage 111, or two-dimensionally scans in the XY plane directions (directions along the light irradiation region) by the driving of the X axis stage 111 and the Y axis stage 109. As a result, the focal point of the acoustic lens 103 is scanned one-dimensionally (X direction) or two-dimensionally in the XY plane directions (directions along the light irradiation region) at the above mentioned depth in the object 113. Here the scanning range (range where the focal position of the acoustic wave detection element is scanned) is smaller than the light irradiation region 136. This is because, although the peripheral portion of the light irradiation region 136 is irradiated with light, the intensity of the light is not enough to ensure the required measurement accuracy and the peripheral portion is therefore excluded. In other words, the light irradiation unit having an optical fiber 123 or the like needs to radiate light in a range larger than the two-dimensional scanning range of the focal point to be measured at sufficient accuracy. The size of the light irradiation region 136 is appropriately set in accordance with the measuring conditions or the like.

The signal acquiring unit 130 acquires a reception signal based on the light irradiation and the photoacoustic wave synchronizing with the scanning of the element 101 in a Z direction position of the focal point. The signal processing unit 132 generates a two-dimensional photoacoustic wave image inside the object 113 from the acquired electric signal. In this example, scanning is performed with the element 101, hence the scanning system is simplified. A three-dimensional image may be created by setting a plurality of focal positions in the Z direction that is two-dimensionally scanned, sequentially performing two-dimensional scanning at each position in the Z direction, and combining the two-dimensional image at each position in the Z direction. In this case, a three-dimensional image exceeding the upper limit of the depth of focus can be acquired. In the support table 115, the element may be moved in steps in the Z direction to a Z direction position where the next two-dimensional scanning is performed every time a two-dimensional scanning ends, as a configuration to change a position in the Z direction. If a Z direction moving mechanism (moving unit) is disposed and manually operated for this movement in the Z direction, then no driving mechanism, such as the X axis stage 111 and the Y axis stage 109 (moving units), need be disposed. Therefore the apparatus 1000 can be compact. However, the present invention is not limited to this, and the support table 115 may be automatically changed to position in a Z direction by using electric control.

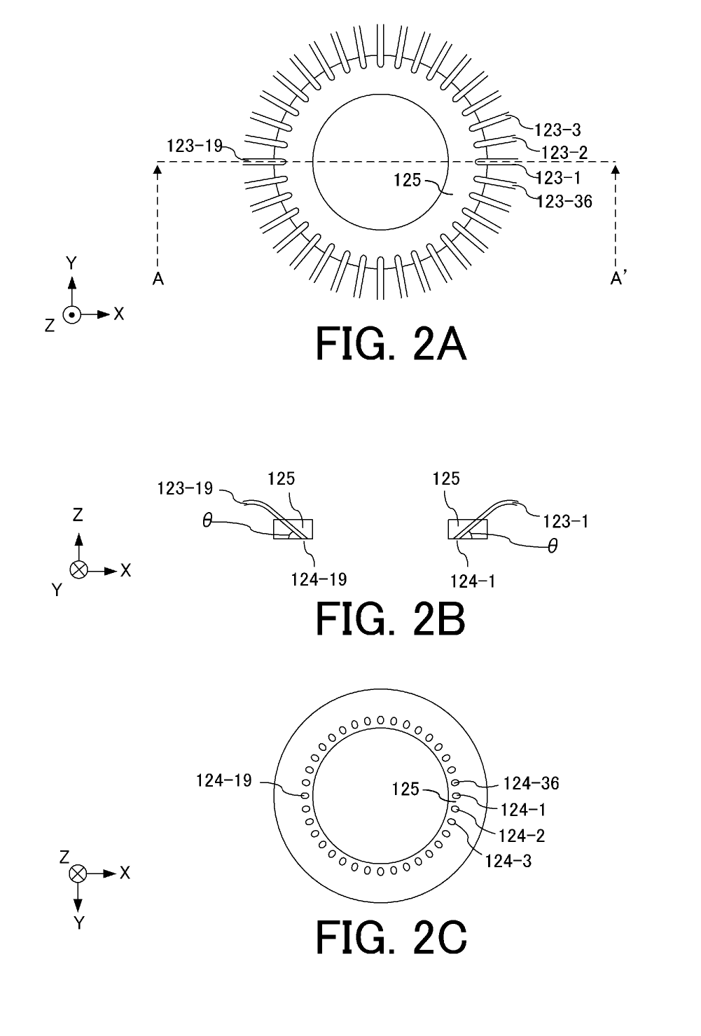

FIG. 2A to FIG. 2C are diagrams depicting a structure of the light irradiation unit according to Example 1, where a portion the same as FIG. 1 is denoted with a same numeral, for which unnecessary description is omitted. FIG. 2A is a plan view of the light irradiation unit, FIG. 2B is a cross-sectional end view sectioned at the A-A′ line in FIG. 2A, and FIG. 2C is a bottom view. FIG. 2A to FIG. 2C show a case when 36 optical fibers 123 are used. In the apparatus 1000 of this example, it is preferable that the light is radiated in a range that is equivalent to or larger than the scanning range of the focal positions by the element 101. It is preferable that the light is radiated as uniformly as possible, in order to reduce dependence of the intensity of the electric signal outputted from the element 101 (reception signal) on the scanning position.

In FIG. 2A, the optical fiber support unit 125 is configured to dispose the optical fibers 123-1 to 123-36 in a circle. Each end face 124 of the optical fibers 123 is obliquely cut and polished. In FIG. 2B, the angle θ of each optical fiber 123 in the optical fiber support unit 125 is 35°. In other words, the optical fibers 123-1 to 123-36 are supported so that the irradiation angle of light in water is 35° with respect to the circular opening surface of the optical fiber support unit 125. The spread angle (NA) of the optical fiber 123 in water that is used here is 0.075. The position of the optical fiber support unit 125 is adjusted to be a 13 mm height in the Z direction from the focal position of the element 101. The end faces 124-1 to 124-36 are disposed on the circumference of the circle of which diameter is 49 mm.

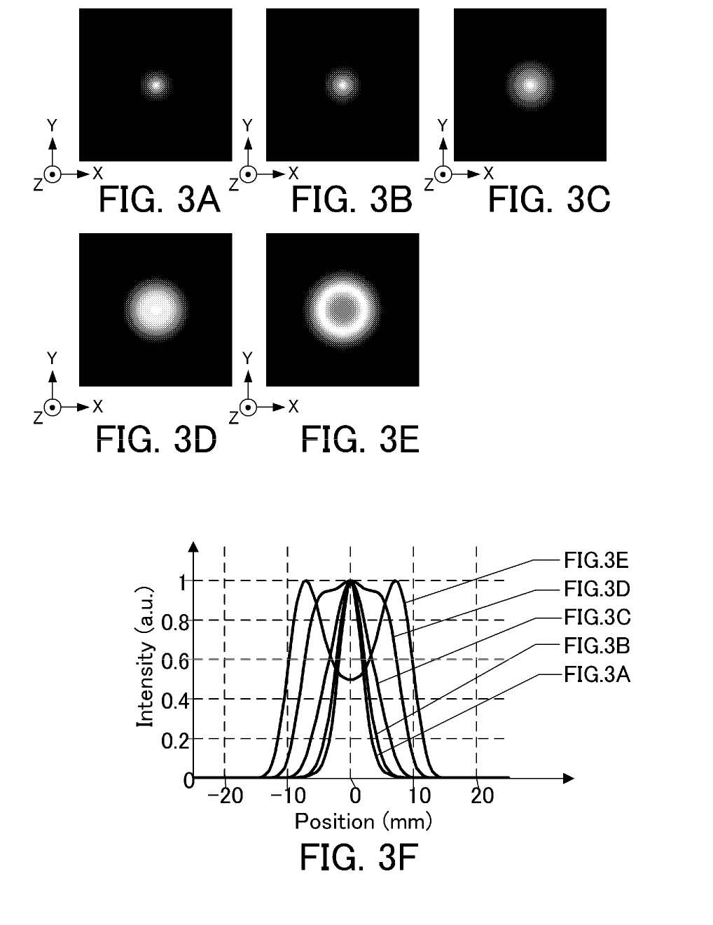

FIG. 3A to FIG. 3F are diagrams depicting light distribution in the light irradiation region according to Example 1. The light distribution in the light irradiation region has a close relationship with the diameter of the circle where the end face of the light transmission unit is positioned. FIG. 3A, FIG. 3B, FIG. 3C, FIG. 3D and FIG. 3E are the light distributions in the case when each diameter is 37 mm, 41 mm, 45 mm, 49 mm and 53 mm respectively. The abscissa of FIG. 3A to FIG. 3E indicates the X scanning direction of the apparatus 1000, and the ordinate indicates the Y scanning direction. FIG. 3F shows the light distribution at each center portion of FIG. 3A to FIG. 3E respectively. As FIG. 3F shows, the light intensity is approximately constant in the ±5 mm range from the center if the diameter is 49 mm.

Therefore according to the apparatus 1000 of this example, if the target observation portion of the object 113 is disposed in a circle of which diameter is 10 mm and scanning range of the element 101 is inside this circle, then an image, of which dispersion of intensity which depends on the scanning position is small, can be acquired. An optimum size of the diameter of this circle is appropriately determined considering: the resolution of the image to be acquired; the manufacturing accuracy of the scanning system (i.e. the X axis stage 111 and the Y axis stage 109); and the optical system (i.e. the optical fibers 123). In FIG. 3D, the intensity of light at each point in the ±5 mm range from the center is approximately 90% or more of the maximum value. The present invention is not limited to this, and the maximum value can be appropriately changed according to the required measuring accuracy. Further, the distance from the light irradiation end of the optical fiber to the surface of the object, the size of the light irradiation region, the size of the light irradiation end face 124, a number of the optical fibers 123, and the light irradiation intensity are determined during the design phase.

### Example 2

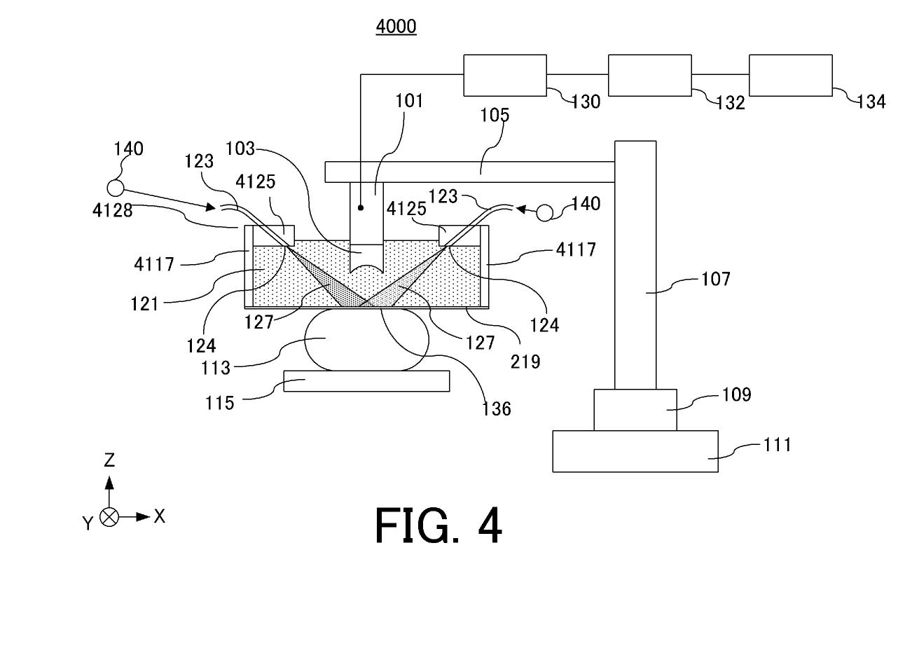

FIG. 4 is a diagram depicting Example 2 of the object information acquiring apparatus according to the embodiment of the present invention, where a composing element the same as Example 1 is denoted with a same number, for which description is omitted. A composing element similar to Example 1 is denoted with a same number set prefixed by a “4”, i.e. 128 in Example 1 becomes 4128 in Example 2, and the description of which is omitted as much as possible. The difference between the object information acquiring apparatus 4000 (hereafter called “apparatus 4000”) of this example and the apparatus 1000 of Example 1 is the optical fiber support unit 125 and a side wall 4117 of a water tank 4128 are integrated. As a result, the distance between the portion of the thin film 219 of the water tank and the emission end of the light irradiation unit 4125 can be maintained to be approximately constant, which improves the stability of the light intensity distribution in the light irradiation region. Further, operability of the apparatus 4000 improves even more if a Z direction moving mechanism is disposed in the water tank 4128, independently from the Z direction moving mechanism of the support table 115. In other words, the surface of the object 113 on the light irradiation side presses against the thin film 119, hence the light irradiation surface side of the object 113 could deform. Hence the focal position in the Z direction may shift from a desired position. Therefore, by moving the water tank 4128 side in the Z direction, distortion can be better adjusted compared with the case of adjusting the position of the object 113 in the Z direction using only the Z direction moving mechanism of the support table 115, and a desired focal position in the Z direction can be obtained more easily. The Z direction moving mechanism of the support table 115 and the Z direction moving mechanism disposed in the water tank 4128 can be manual mechanisms since it is sufficient to roughly align the depth of the object to be imaged to a range of the depth of focus. Therefore, a manual operation mechanism is used, whereby the apparatus size is not increased as in the case of the X axis stage 111 and the Y axis stage 109.

### Example 3

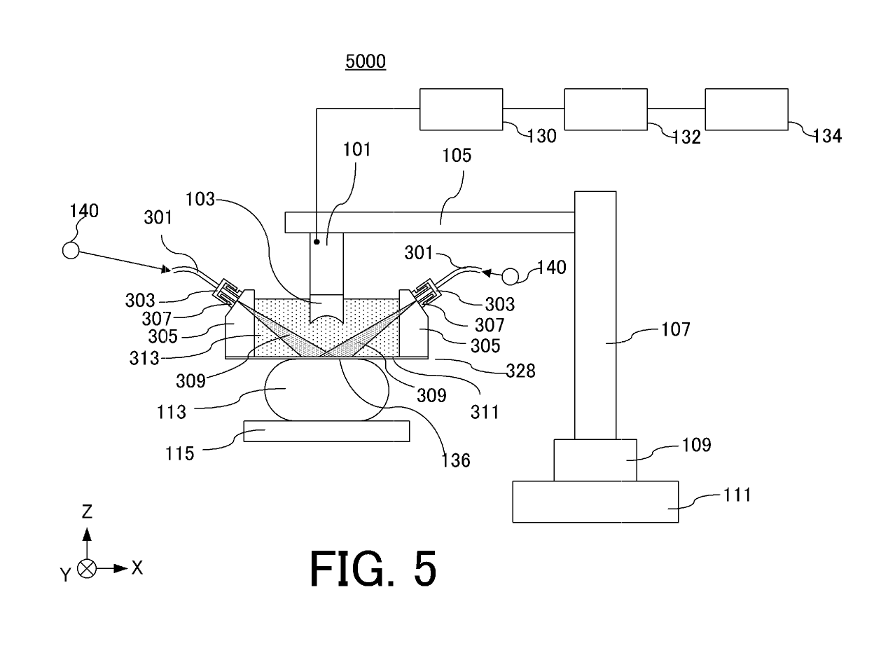

FIG. 5 is a diagram depicting Example 3 of the object information acquiring apparatus according to the embodiment of the present invention, and a same composing element as Example 1 is denoted with a same number, for which description is omitted. A difference of the object information acquiring apparatus 5000 (hereafter called “apparatus 5000”) of this example from the apparatus 1000 of Example 1 is that the optical fiber 301 is detachable from a water tank 328.

At the tip of the optical fiber 301, a connector 303, to connect with the water tank 328, is disposed. The water tank 328 is constituted by a side wall 305 and a thin film 311, where water 313, to acoustically couple the object 113 and the acoustic lens 103, is filled. A connector receiving unit 307 is disposed on the side wall 305 at a desired position. The connector receiving unit 307 is detachable from the connector 303. The optical fiber 301 emits light 309 in a state where the connector receiving unit 307 and the connector 303 are connected. In this example, the light 309 propagates through the side wall 305, therefore the side wall 305 is constituted by a member that can transmit light.

This configuration makes it possible to replace a damaged fiber alone if an optical fiber is damaged, for example, hence repair is easier.

### Other Examples

In the above mentioned examples, optical fibers are used as the light transmission unit, but the present invention is not limited to this, and the light transmission unit may be an optical element such as a mirror and a lens that propagates the light in a space. In this case, the optical system should be designed such that a range larger than the target observation portion of the object is set as the light irradiation region.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Those skilled in the art can easily construct a new system by combining various techniques of each example described above, therefore such a system constructed by various combinations of these techniques is also included in the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-201034, filed on Sep. 30, 2014, which is hereby incorporated by reference herein in its entirety.

What is claimed is:

1. An object information acquiring apparatus comprising:
a light source that generates light;
a light irradiation unit that causes an acoustic wave to be generated from an object by irradiating a light irradiation region on a surface of the object with the light;
a reception unit that receives the acoustic wave;
an acoustic lens that is disposed such that the reception unit can selectively receive the acoustic wave from a predetermined direction;
a moving unit that moves a focal point of the acoustic lens inside the object in an in-plane direction of the light irradiation region; and
an acquisition unit that acquires information on a characteristic of the object based on the reception result of the reception unit, wherein
the size of the focal point formed by the acoustic lens is smaller than the light irradiation region.

2. The object information acquiring apparatus according to claim 1, wherein
the light irradiation region is a predetermined region on the surface of the object.

3. The object information acquiring apparatus according to claim 1, wherein
the moving unit moves the focal point of the acoustic lens also in a normal line direction with respect to the light irradiation region.

4. The object information acquiring apparatus according to claim 1, wherein
the moving unit moves the focal point of the acoustic lens in the light irradiation region.

5. The object information acquiring apparatus according to claim 1, further comprising an acoustic coupling agent that is disposed between the acoustic lens and the object, and propagates the light and the acoustic wave.

6. The object information acquiring apparatus according to claim 5, further comprising a container constituted by a bottom portion that is disposed between the acoustic coupling agent and the object, and propagates the light and the acoustic wave, and a side portion that, together with the bottom portion, holds the acoustic coupling agent.

7. The object information acquiring apparatus according to claim 6, wherein
the light irradiation unit includes an optical fiber configured to transmit light generated from the light source and perform irradiation.

8. The object information acquiring apparatus according to claim 7, wherein
the light irradiation unit further includes a support unit that supports the optical fiber.

9. The object information acquiring apparatus according to claim 8, wherein
the support unit and the side portion are integrated.

10. The object information acquiring apparatus according to claim 7, wherein
the light irradiation unit also serves as the side portion.

11. The object information acquiring apparatus according to claim 10, wherein
the optical fiber is detachably disposed on the side portion.

12. The object information acquiring apparatus according to claim 7, wherein
the optical fiber has an end face which radiates the light and contacts the acoustic coupling agent.

13. The object information acquiring apparatus according to claim 12, wherein
the optical fiber is provided in plurality, and
the end faces thereof are disposed in a circular shape.

14. The object information acquiring apparatus according to claim 13, wherein
the end faces are disposed in a form of a plurality of concentric circles.
